(19) United States
(12) Patent Application Publication
(10) Pub. No.: US 2006/0253356 A1
(43) Pub. Date: Nov. 9, 2006

(54) Methods and devices for displaying and communicating complex financial information

(75) Inventors: Ian Charles, Carrollton, TX (US); Todd Konkel, McLean, VA (US); Veeral Rathod, Sherman, TX (US)

Correspondence Address: GREENBERG TRAURIG, LLP;Fifth Floor, 1900 University Avenue, East Palo Alto, CA, 94303, US

(73) Assignee: Cogent Partners, LP

(21) Appl. No.: 11/123,264

(22) Filed: May 5, 2005

(51) Int. Cl. G06Q 40/00

(52) U.S. Cl. 705/35

(57) ABSTRACT

Methods, systems, displays, apparatus, and processes for displaying and communicating complex information relating to investment portfolios and funds are described. Disclosed are methods, displays apparatus and processes for displaying and communicating overview data and relationships including juxtaposing projected IRR against current IRR for funds of a private equity portfolio. Additionally, a portfolio risk/return analysis is described wherein expected return standard deviation is charted versus expected secondary IRR while fund investment strategy and relative values are simultaneously also indicated. Also disclosed are aspects of the invention displaying general partner bandwidth with correlations to industries of investments and value to invested capital ratios. Also are aspects of the invention relating to communicating projected lifetime fund IRR and secondary fund market values for private equity investments.

This application claims priority to U.S. Provisional Patent Application No. 06/568,396 entitled “Methods and Devices for Displaying and Communicating Complex Financial Information” filed on May 5, 2004, which is herein incorporated by reference in its entirety.

### FIELD OF THE INVENTION

This invention relates to the field of methods, systems, displays, apparatus, business methods and processes for displaying and communicating complex information relating to investment portfolios and funds.

### BACKGROUND OF THE INVENTION

The management of complex financial investments can require the simultaneous understanding of numerous interrelated sets of data. Various methods and means have been developed to assist those responsible for the management of such investments and funds to facilitate their understanding, evaluation and review of these various data elements. Methods used in the past include tables, spreadsheets, and the like. However, there exists a need for improved methods and means of displaying and communicating the complex interrelated data corresponding to various aspects of such investments. This is particularly true for the instance of private equity investors, and those responsible for overseeing or managing private equity investments.

### OBJECTS OF THE INVENTION

Accordingly, it is an object of the present invention to provide display devices, systems and methods for portraying complex data relating to investments and investment vehicles to facilitate efficient communication of data presented. The devices, systems and methods can be used individually or in conjunction with one another to achieve the desired objectives.

It is a further object of the present invention to provide display apparatus, systems and methods for portraying complex data relating to investments and investment vehicles in such a way as to efficiently present interrelationships between separate sets of data relating to the investments.

It is a further object of the present invention to provide methods, apparatus and systems for juxtaposing, for a plurality of private equity funds, current primary IRR versus expected primary IRR.

It is a further object of the present invention to provide methods, apparatus and systems for juxtaposing, for a plurality of private equity funds, current primary IRR versus projected secondary IRR.

It is a further object of the present invention to provide methods, devices and systems visually presenting relationships between fund investment, expected return standard deviation and expected primary or secondary IRR for private equity funds.

Other objects, features and advantages of the invention will be more apparent to those versed in the field of analyzing, displaying and communicating data relating to private equity investments, from the following detailed specification taken in conjunction with the accompanying claims.

### BRIEF DESCRIPTION OF THE DRAWINGS

FIG. 1 is a chart illustrating the basic structure of private equity relationships.

FIG. 2 shows an embodiment of aspects of the present invention showing projected IRR juxtaposed against current IRR for funds of a private equity portfolio.

FIG. 3 shows an embodiment of aspects of the present invention presenting a portfolio risk/return analysis.

FIG. 4 is a grouping of charts, according to aspects of the present invention, showing various diversifications, risks and exposures of a sample private equity portfolio.

FIG. 5 is a presentation, according to aspects of the present invention, parsing out and interrelating data relating to a sample private equity portfolio.

FIG. 6 is a presentation, according to aspects of the present invention, showing for a sample private equity portfolio discretionary ratings for various investment strategy portions of the portfolio and also showing a composite discretionary rating for the sample private equity portfolio.

FIG. 7 exemplifies another aspect of the present invention and shows, for a sample private equity fund, actual fund metrics juxtaposed versus corresponding metrics for a hypothetical fund of the same size that demonstrated “mean performance”.

FIG. 8 is a presentation, according to aspects of the present invention, showing for a sample private equity fund discretionary ratings for a projected secondary value, overall NAV strength, relative performance and expense and fee load as well an overall composite discretionary rating for the sample private equity fund.

FIG. 8a is a presentation, according to alternative aspects of the present invention, showing for a sample private equity fund discretionary ratings for historical performance, projected performance and composite performance for the sample private equity fund.

FIG. 9 is an example, according to aspects of the present invention, of a display and method for presenting analysis of general partner bandwidth of a sample private equity fund.

FIG. 10 is an example, according to aspects of the present invention, of a display and method for presenting analysis of the operational risk exposure of a sample private equity fund.

FIG. 11 is an example, according to aspects of the present invention, of the results of a Monte Carlo analysis for the projected lifetime IRR of a sample private equity fund.

FIG. 12 is an example, according to aspects of the present invention, of the results of a Monte Carlo analysis for the projected secondary fund market value of a private equity fund.

FIG. 13 is an example, according to aspects of the present invention, of a display of private equity fund news with a legend indicating positive or negative interpretation of each displayed news item with a relative weighting to each such positive or negative indication.

FIG. 14 is any example, according to aspects of the present invention, of a presentation of the projected fund cash flow cycle for a particular fund.

FIG. 15 is any example, according to aspects of the present invention, of a display and presentation of data relating to portfolio aging of a particular fund.

FIG. 16 is a visual representation of data regarding projected primary IRR sensitivity for a particular fund.

FIG. 17 is an exemplary embodiment of a visual representation of estimated secondary transaction value sensitivity according to aspects of the present invention.

FIG. 18 is an exemplary embodiment of a visual representation of estimated secondary transaction value sensitivity in relation to a particular fund according to aspects of the present invention.

FIG. 19 is a visual representation of presentation of important relationships and data regarding coinvestors in a particular fund according to aspects of the present invention.

FIG. 20 illustrates aspects of the present invention and displays a venture fund performance matrix according to the present invention.

### DESCRIPTION OF THE INVENTION

The term “private equity” refers to a broad set of investment strategies ranging from seed-stage venture capital investments to billion-dollar leveraged buyout acquisitions.

Private equity investments are typically made through a partnership composed of investors, also known as “limited partners”, and a legal entity known as the “general partner”. These partnerships generally have a fixed life of 10 years, with extension provisions that can extend the partnership's life by one to two or more years.

Private equity firms may raise a series of private equity funds, each managed separately with its own limited partners and a unique general partner. It is not uncommon for a successful private equity firm to raise seven or eight consecutive funds over a 10 to 15 year period.

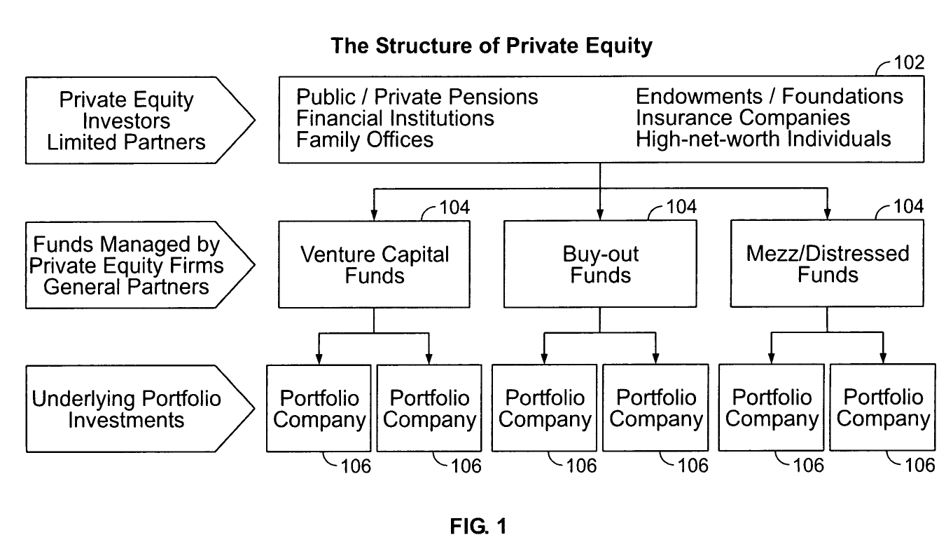

FIG. 1 illustrates the general structure of private equity relationships. Shown at 102 are the private equity investors, who are usually limited partners. Typical examples of private equity investors include public and private pensions, financial institutions, family offices, endowments and foundations, insurance companies and high net worth individuals. Shown at 104 are exemplary types of funds, each type shown having a different type of investment strategy, in which the private equity investors may be invested. Examples of investment strategies of such funds include venture capital, buyout, mezzanine and distressed, international, opportunistic, real estate, special situations, growth capital and others. The funds may individually be invested according to a variety or combination of strategies. The funds are managed by general partners (portfolio managers), typically part of private equity firms. Shown at 106 are examples of portfolio companies in which the various funds are invested.

In the instance of private equity investors, typically a chief investment officer or director of investments bears responsibility of overseeing the performance evaluation and management of the various investments held. A typical private equity investor would probably be invested as a limited partner in a variety of private equity funds. Each of these private equity funds, in turn, would be invested in a plurality of portfolio companies. Thus, these investment officers are presented with a daunting task of oversight and management. This is made more difficult owing to the nature of the portfolio companies in which the funds are ultimately invested. Many of them are yet privately held, and the work entailed in the collection, assimilation and analysis of data for the potentially very numerous portfolio companies in which investments are held frequently strains the bandwidth of the investment officers. Their task is further complicated by their typical extra responsibilities of continuous performance and risk monitoring, asset allocation management, sourcing and evaluating new investment opportunities, other alternative asset commitments, financial reporting and investment board meetings, distribution management annual meeting attendance.

The present invention provides highly efficient displays, juxtapositions of information, methods, systems and devices to greatly enhance the ability of the investment officer to comprehend complex data, track and project performance, interrelate disparate data and assimilate analytical results relating to private equity portfolios and funds. Such can be communicated to a receiving party or user by way of printed media, electronic media or other methods to provide the interrelated visual representations of the present invention

From time to time private equity investors choose to end their participation in the partnership of a particular fund. At such times, they can liquidate their interest in the particular fund through a “secondary market”. Accordingly, the interests of the private equity investors sold in such secondary markets are termed “secondaries”. Original interests in the funds are termed “primary”.

Optimal decision making by the investment officers is enhanced if some understanding of projected secondary values can be ascertained for investment positions and be cited with, versus and juxtaposed with other data and analysis of the investment. The present invention also has specific application and utility in this regard.

The investment officers for the limited partners in private equity funds have significant needs of the advantages of the present invention, which provide highly efficient data representations, relational relevancies, and comparisons by visual and other communicative means of complex information.

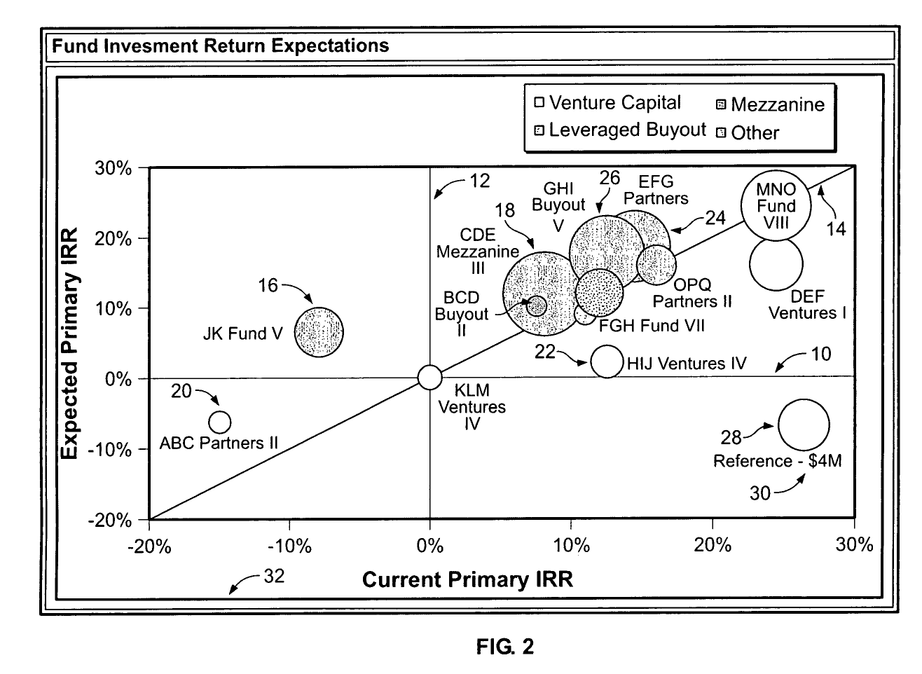

It has been found useful to analyze a private equity portfolio both in terms of the entire portfolio and in terms of individual funds in which the limited partner is invested. FIGS. 2, 3, 4, 5 and 6 below illustrate aspects of the present invention designed principally for application in instances of analysis of the overall portfolio held by the limited partner. FIGS. 7-19 below illustrate aspects of the present invention having particular application with regard to individual funds. Reports for an investor regarding an overall portfolio can be generated using all or a combination of the aspects of the invention illustrated in FIGS. 2-6. Such reports can be combined with additional detail and description of factors helpful in analyzing the portfolio and/or its performance. Reports can also be generated or developed for individual funds using all or a combination of the aspects of the present invention shown in FIGS. 7-19. Again, such reports can be combined with additional detail and description of factors helpful in analyzing the particular funds addressed by the reports. Regular reports of not only an overall portfolio but also of the individual funds included in the portfolio can be generated and used to quickly comprehend, analyze and appreciate significant considerations relevant to the portfolio and particular funds.

Definitions:

By “internal rate of return” or “IRR” is meant the discount rate that equates the net present value (NPV) of an investment's cash inflows with its cash outflows. Unless otherwise specified herein, “IRR” refers to “net IRR”, which means the IRR of a portfolio or fund taking into account the effect of management fees, expenses and carried interest.

By “vintage” is meant the year of a private equity fund's formation and first takedown of capital from limited partners.

By “net asset value” or “NAV” is meant the total market value of a fund's portfolio investments and other assets, less any liabilities. The capital account of each limited partner in a private equity fund is typically allocated a pro rata share of the fund's NAV.

FIG. 2 illustrates several aspects of the present invention and shows a device or method for displaying information relating to fund investment return expectations. FIG. 2 comprises a two-dimensional display of a variety of interrelated sets of data relating to the funds of a sample private equity portfolio. Shown in FIG. 2 are two axes, 10 and 12, aligned, respectively, as X- and Y-axes that intersect perpendicularly. X-axis 10 represents the current primary IRR of the various private equity funds illustrated in FIG. 2. Y-axis 12 represents the expected primary IRR of the funds displayed in FIG. 2. Also shown is reference line 14, shown in FIG. 2 as a diagonal line between X-axis 10 and Y-axis 12. Reference line 14 represents the point at which the current primary IRR of a fund equals the expected primary IRR of the same fund. Also shown in FIG. 2 are geometric shapes such as at 16, 18, 20, 22, 24 and 26 each representing a separate fund of the portfolio of FIG. 2. Shown at 28 is a reference geometric shape that also includes a legend 30 identifying a value relating to the relative size of geometric shape 28 versus the sizes of geometric shapes 16 through 26. By visual reference to the reference shape 28 the reviewer of the display shown in FIG. 2 can easily ascertain the approximate relative values of the funds represented by each of the geometric shapes 16 through 26. Additionally, there is provided a legend 32, a color scheme, crosshatching scheme or other scheme used with geometric shapes 16 through 28 to identify the dominant investment strategy of the illustrated funds. The types of investment strategies represented by the funds of the example shown in FIG. 2 include venture capital, leveraged buyout, mezzanine and other. In alternate embodiments of the present invention reference geometric shape 28 can represent the total exposure (NAV plus unfunded commitment) in a particular fund, or just the NAV of a fund, or just unfunded commitment relative to a fund, or total commitment size of a fund, or just contributed capital in a fund.

As can be seen, FIG. 2 efficiently displays each fund's current and expected (or projected) IRR. Those funds whose geometric shape lies above the reference line 14 have expected IRRs that exceed their current primary IRR. Funds whose geometric shape lies below reference line 14 have expected IRRs below their current primary IRR. Not only the type of investment strategy of each fund but the relative investment exposure in each fund is readily shown. Further, the current primary IRR of each of the various funds is readily apparent for comparison with that of the other funds. So, also, is the expected primary IRR of each of the funds.

In the embodiment of the present invention shown in FIG. 2, the current primary IRR is shown on the X-axis 10. The current primary IRR represents the IRR from initial funding to the date of the chart shown in FIG. 2. The expected (or projected) primary IRR is shown on the Y-axis 12 and represents the expected primary IRR of the fund from initial funding to the estimated fund termination date. However, in various alternate embodiments of the present invention, both the X-axis 10 and Y-axis 12 can represent other indices. For example, the Y-axis 12 could instead represent the expected gross IRR. By “expected gross IRR” is meant the expected IRR based upon the performance of the investments, not taking into account management fees, expenses or carried interest. Additionally, the Y-axis 12 could represent the expected secondary IRR. By “expected secondary IRR” is meant an IRR calculation from the perspective of a secondary investor that begins with the current par value of the fund investment as an initial cash outflow and factors in all projected future cash inflows and outflows associated with the secondary fund investment. Alternatively the X and Y axes could represent in one axis any metric of historical fund performance and the other axis any metric of projected fund performance.

In some embodiments of the invention illustrated in FIG. 2, because of the large number of funds held in a particular portfolio, multiple displays of FIG. 2 can be provided with separate displays for those funds of each or at least some separate investment strategies or other preferred category.

FIG. 2 provides signifant advantages to a portfolio manager. In one quick easily comprehended visual image it presents relative data on a variety of funds. The conveyed data includes, for example, the relative value of the respective funds, the relative current primary IRR, the relative expected primary IRR, the investment type of each fund, whether any individual fund's expected performance exceeds or lags its current performance, the degree to which any fund so exceeds or lags and the degree of each fund's exceeding or lagging in relation to any other displayed fund's exceeding or lagging. Various other advantages are apparent from the Figure as well, as they are from each of the figures of this specification.

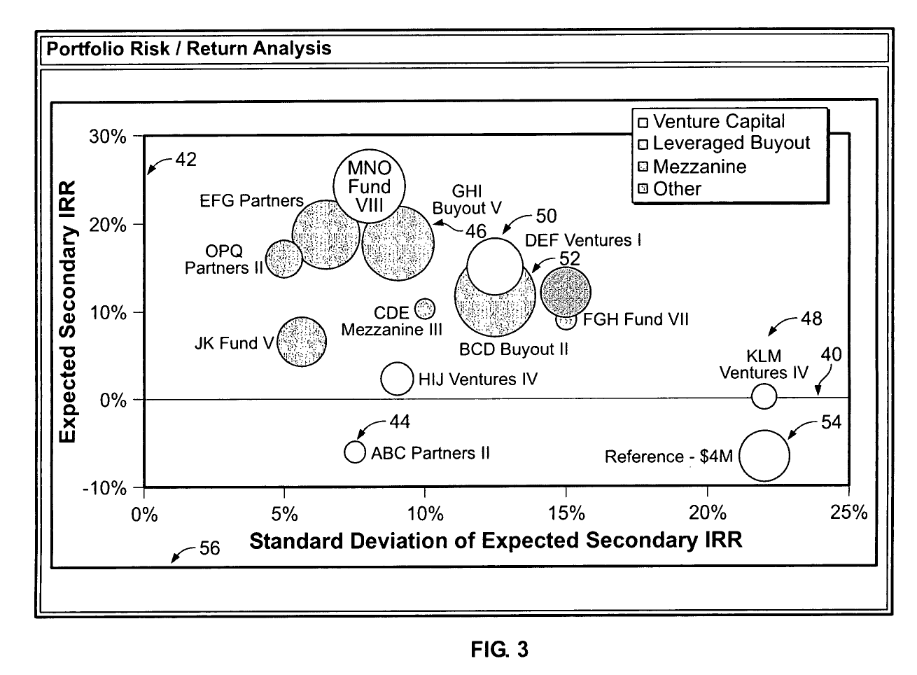

FIG. 3 illustrates an additional aspect of the present invention. FIG. 3 embodies a method of display and a display showing the operating risk to which a sample portfolio is exposed charted versus a return expectation analysis.

Shown in FIG. 3 is X-axis 40 that intersects perpendicularly with Y-axis 42. X-axis 48 represents the expected return standard deviation for the funds displayed in FIG. 3. Y-axis 42 represents the expected secondary IRR of the funds represented on FIG. 3. However, it should be noted that in alternate embodiments of the present invention Y-axis 42 may instead represent the expected primary IRR of the funds. Geometric shapes, 44, 46, 48, 50 and 52 represent funds of the portfolio presented in FIG. 3. Reference shape 54 provides an indicator of the relative values of investments held in shown as geometric shapes in FIG. 3. The size a geometric shapes 44, 46, 48, 50 and 52, respectively, correspond to the size of the reference shape 54 and the value of the portfolios investment in each fund, respectively. It should be noted that in the embodiment of FIG. 3, the sizes of the geometric shapes are proportional to the sum of the net asset value of the investor's capital account and investors unfunded commitment in the funds represented by the respective geometric shapes. Legend 56, through various optional marking schemes, identifies the investment strategy relating to each fund represented by a geometric shape.

The size of the geometric shapes 46, 48, 50, and 52 in the embodiment shown in figure three, correspondent to the amount of commitment made by the portfolio to each respective fund. In alternate embodiments, the size of the geometric shapes may be related to the amount of capital already funded for each fund or the amount of capital to be still provided from the private equity investor. Additionally in the alternate of embodiments, a legend may be provided to identify the stage in the business development cycle of the respective funds represented by the geometric shapes of FIG. 3.

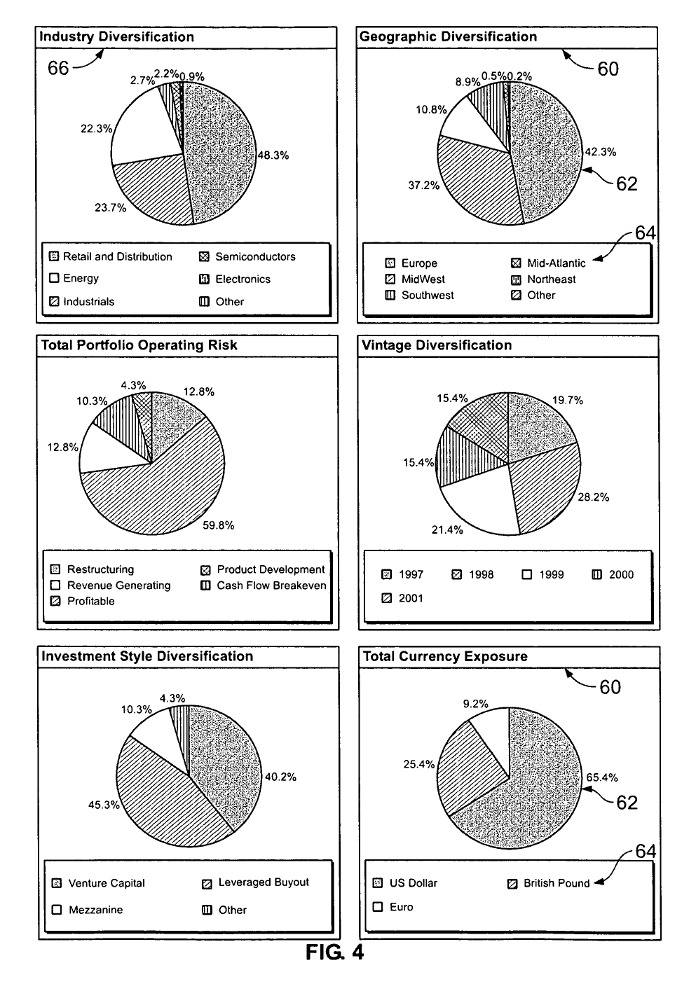

FIG. 4 illustrates yet another aspect of the present invention. FIG. 4 shows six separate charts 60, each comprising a title 66, pie chart 62 and legend 64. The charts in FIG. 4 display facts and the results of analysis relating to the aggregate of the funds of a portfolio. For example, the chart labeled industry diversification 66 of FIG. 4 represents the industry diversification of the aggregate of the funds represented in the portfolio being addressed. Similarly, the other charts of FIG. 4 represent, respectively, the geographic diversification, total portfolio operating risk, vintage diversification, investment style diversification, and total currency exposure of the aggregate of the funds of the represented portfolio. Accordingly, FIG. 4 can serve as a complement to and be used in conjunction with the displays of FIGS. 2 and 3 to efficiently convey and communicate complex but related information regarding a portfolio.

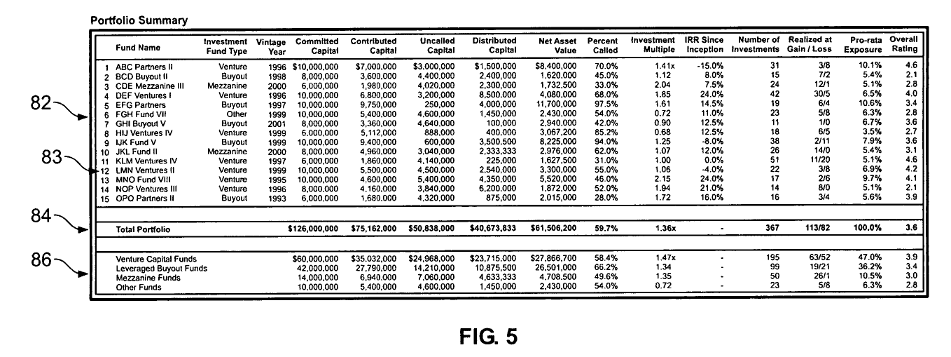

The assembly of charts of FIG. 4 could also include additional charts covering such analysis as diversification of underlying holdings by asset type (private securities, public securities, cash, etc.). Additionally, some of such additional charts could be substituted for some of the charts shown in FIG. 4. Also, FIG. 4 need not include all six charts shown and can include a lesser or greater number depending on the particular set of relationships and related information that is deemed best to communicate. The data of FIG. 5 can be cross-indexed with data and symbols of other displays as exemplified in the present specification. This provides accurate detailed data for the relative relationships indicated in other displays herein.

FIG. 5 illustrates yet another aspect of present invention. Accumulated data for a plurality of funds, such as the funds of the sample portfolio shown in FIGS. 2, 3 and 4 is presented. The various columns of section 82 represent particular data broken out for each fund recited. The first column of section 82 shows the fund name. The next column identifies the fund type—such as a venture or buyout, mezzanine or other type of fund. Next is shown the vintage year of each particular fund. The next column shows the committed capital, i.e., the capital committed by the limited partner to the particular fund of the portfolio. The next column shows the contributed capital, which represents that amount of capital already contributed by the limited partner to each fund. Shows the as yet uncalled capital for the fund. The next column, distributed capital, represents those funds already distributed from each particular fund back to the limited partner. The net asset value column shows the present value of the limited partner's interest in each of the funds shown in FIG. 5. The column labeled “Percent Called” represents that percentage of the committed capital that has been called to date by each of the funds. The column labeled “Investment Multiple” represents NAV plus distributed capital, the sum of which is divided by contributed capital. The column labeled “IRR Since Inception” shows the internal rate of return of each fund since that fund's inception. The next column shows the number of investments currently held in each fund. “Realized at Gain/Loss” shows the number of companies in each fund that have been fully realized (exited or otherwise disposed of) at a gain as those that have been fully realized at a loss. The next column, labeled “Pro-rata Exposure” shows the pro-rata exposure in each fund of the total portfolio. The final column, labeled “Overall Rating” represents a rating assigned to each fund based on discretionary analysis of a broad cross-section of data from each fund, including, but not limited to Historical Performance, NAV Strength, Secondary Value, and Fee and Expense Load of each fund.

Section 84 of FIG. 5 shows, in appropriate respective columns, either the accumulated total of the data of each column or the mean of the data of each column.

Section 86 of FIG. 5 shows a different type of accumulated data from each of the columns of FIG. 5. As can be seen, separate totals or capital weighted means as per investment strategy are calculated for the data of the funds. In the embodiment of the present invention shown in FIG. 5, separate totals or capital weighted means are calculated and displayed for the following four categories of investment strategies: Venture Capital Funds, Leveraged Buyout Funds, Mezzanine Funds and Other Funds.

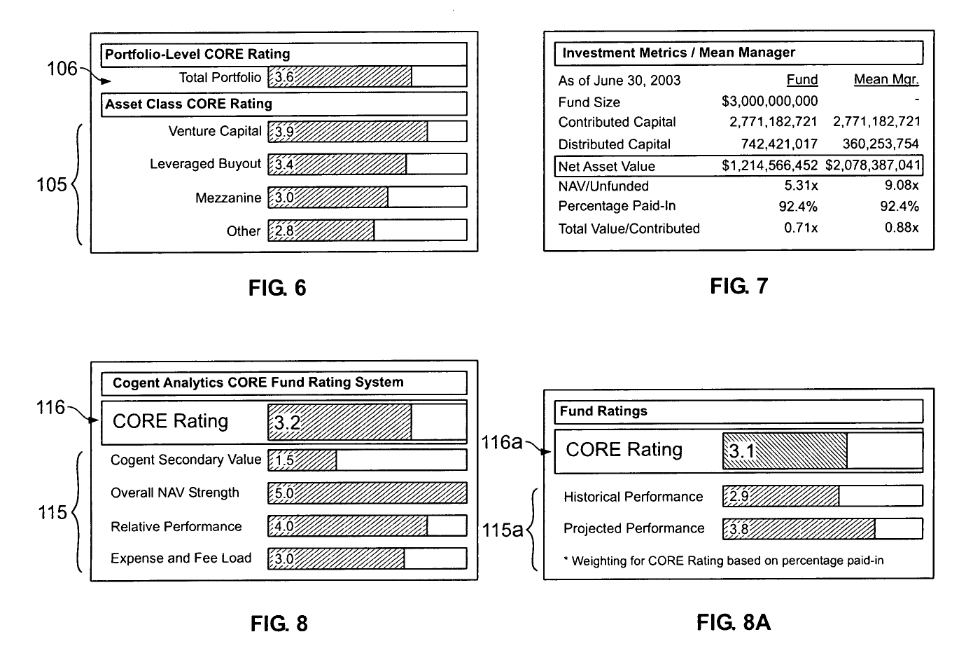

FIG. 6 illustrates another aspect of the present invention and shows discretionary ratings for both particular aspects 105 of the portfolio and a composite discretionary rating 106 for the portfolio. As an example of particular aspects of the portfolio that can be rated and represented at 105, FIG. 6 shows a discretionary rating for various investment strategy portions of the portfolio. In the embodiment of FIG. 6 is shown a discretionary rating for each of the categories of investment strategies of: Venture Capital, Leveraged Buyout, Mezzanine and Other. The individual discretionary ratings comprise results of a discretionary analysis of a broad range of data and factors relating to that portion of the funds to which the respective investment strategy applies. In alternate embodiments, section 105 may comprise discretionary ratings of fewer criteria, additional or other criteria, analysis factors, or perspectives relating to the portfolio. FIG. 6 additionally provides a composite discretionary rating 106 applying to the entire portfolio. This composite discretionary rating comprises a capital weighted mean of the discretionary ratings of the individual fund investments in the portfolio. In alternate embodiments of the present invention, the composite discretionary rating may be derived by weighting other criteria such as an arbitrarily defined “importance” factor or other criteria. Additionally, the composite discretionary rating may be compiled without a weighting or may represent the result of a completely independent rating analysis of the portfolio. While the graphics used in depicting the discretionary ratings of FIG. 6 are in the form of bar charts with numerical labels, it is within the contemplation of the present invention that numerous other graphical means, such as stars, circles or other means, can be employed to depict the relative ratings shown in FIG. 6.

FIGS. 7-19 relate to aspects of the present invention having particular application to display methods, apparatus and inventions relating to analytics of individual funds versus entire portfolios. Aspects of the display methods of FIGS. 7-19 may be cross-referenced or otherwise linked to each other or to relevant points in the presentations of displays as shown in FIGS. 2-6 and 20.

FIG. 7 provides a comparison of actual fund metrics versus the corresponding metrics for a hypothetical fund of the same size that demonstrated “mean performance” in the market. The mean performance data can be developed independently for each presentation of the invention of FIG. 7 or, alternatively, can be obtained from various commercial sources, such as Thomson Financial Venture Economics. In the aspect of the present invention shown in FIG. 7, fund size, contributed capital, distributed capital, net asset value, NAV/Unfunded (NAV divided by the capital commitments that have not yet been contributed to the fund), percentage paid-in and total value/contributed are shown for the fund being evaluated. The comparison data for the hypothetical mean fund is provided, in the embodiment exemplified in FIG. 7, under the heading “Mean Mgr”. For comparative purposes values for Contributed Capital and the Percentage Paid-In for the Mean Mgr column are inserted that are equal to the values of the Contributed Capital and Percentage Paid-In for the particular fund being presented in FIG. 7. The remaining values then for the Mean Mgr. column are calculated from the data of the hypothetical mean fund pro-rata on the basis of the supplied value for Contributed Capital.

FIG. 8 shows a set of discretionary ratings for the particular fund being analyzed. The individual discretionary ratings comprising results of a discretionary analysis of a broad range of data and factors relating to the fund. Ratings are shown for particular metrics or analysis perspectives 115 and for a composite or overall rating 116 for the fund. Ratings are shown for Secondary Value, Overall NAV Strength, Relative Performance and Expense and Fee Load. The Secondary Value rating reflects the conclusions of discretionary analysis of a number of factors to arrive at a relative proposed value in the secondary market of the investment. The Overall NAV Strength, Relative Performance and Expense and Fee Load ratings similarly reflect conclusions and discretionary analysis of a number of factors to arrive at a relative rating for these respective matters in comparison with other funds. FIG. 8 additionally provides a composite overall discretionary rating for the fund 116. The composite overall rating 116 may be generated by weighted averaging of the individual metrics 115 or by other overall analysis methods for the fund. While the graphics used in depicting the discretionary ratings of FIG. 8 are in the form of bar charts with numerical labels, it is within the contemplation of the present invention that numerous other graphical means, such as stars, circles or other means, can be employed to depict the relative ratings shown in FIG. 8.

FIG. 8a shows an alternate embodiment of the aspects of the present invention shown in FIG. 8. As shown in FIG. 8a, the present invention contemplates that a variety of particular metrics or analysis perspectives 115a can be presented. For example, in FIG. 8a, the particular metrics or analysis perspectives presented are Historical Performance and Projected Performance of the fund being rated. In the particular embodiment of FIG. 8a, the composite rating 116a represents the average of the ratings of the particular metrics 115a but weighted based on the percentage of commitment to the fund already paid and expected to be paid in to the fund. Alternate embodiments could weight the composite rating on other criteria or not weight the composite rating at all.

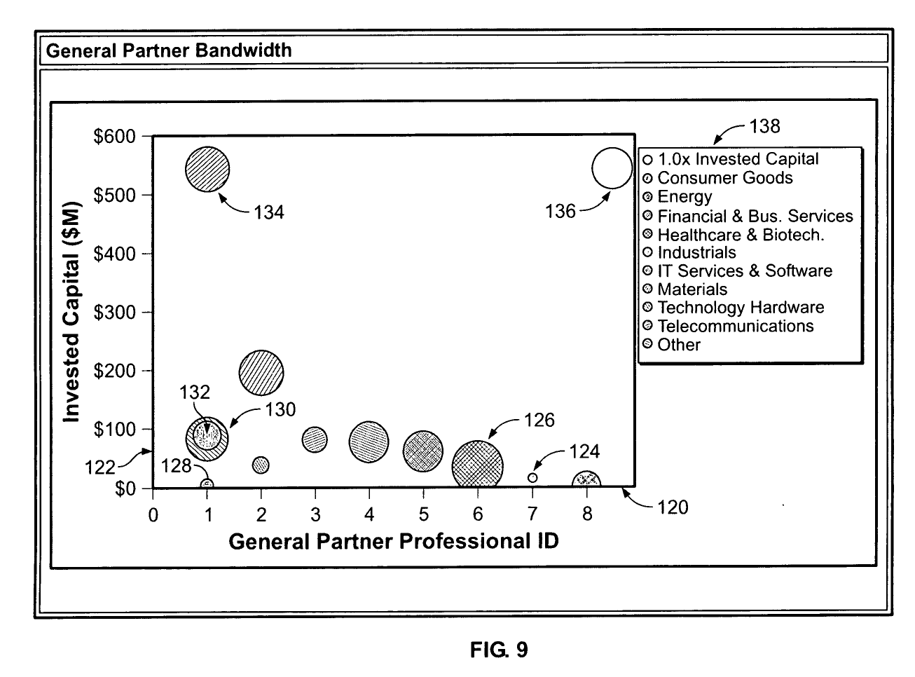

FIG. 9 exemplifies another aspect of the present invention. Two axes are presented, in this embodiment intersecting each other perpendicularly. The X-axis 120 is labeled General Partner Professional ID and is numbered 0 through 8. Each of numbers 1-8 corresponds to a separate professional fund manager at the General Partner that administers the fund represented by FIG. 9. A separate legend identifies which professional corresponds to each of numbers 1-8. The Y-axis 122 is labeled Portfolio Company Value ($M) and is used to indicate the holding value of investments under management by individual fund managers as additionally described below. Corresponding to each of the numbers of X-axis 120 is one or more geometric shapes such as at 124, 126, 128, 130, 132 and 134. Also shown is reference geometric shape 136. As indicated in legend 138, reference geometric shape 136 is a reference performance metric and represents an investment whose holding value is equal to its invested capital. Reference geometric shape 136 provides a relative basis for visually comparing the sizes, and consequently, the relative holding-value-to-invested-capital ratio represented by each of the geometric shapes such as 126-134 corresponding to individual portfolio company investments. By comparison with the reference geometric shape 136, the sizes of geometric shapes corresponding to the professionals shown on FIG. 9 and the position of the geometric shapes on the chart of FIG. 9 it is possible to quickly identify the relative amounts of funds managed, on a value basis, by the various fund managers as well as the relative performance of each fund—on a basis of the ratio of the holding-value-to-invested capital ratio for each fund. Additionally, legend 138 also provides a legend of industries in which the assets of the fund are invested as well as color or other identifiers corresponding to each industry. The geometric shapes, such as 120-134, in addition to having a relative size also carry the color or other industry identifier of legend 138 so that the user of FIG. 9 can quickly identify the amount of assets handled by an individual fund manager as well as the industry or variety of industries for which the professional has management responsibilities. In this way the limited partner can quickly identify the bandwidth and industry focus or breadth of individual fund managers associated with the fund. In alternate embodiments of the present invention the Y-axis 122 can alternatively represent Invested Capital for the portfolio companies instead of Portfolio Company Value, it can also represent any selected value or monetary indicator as desired. The relative sizes of the geometric shapes can alternatively represent the projected value to invested capital of a fund.

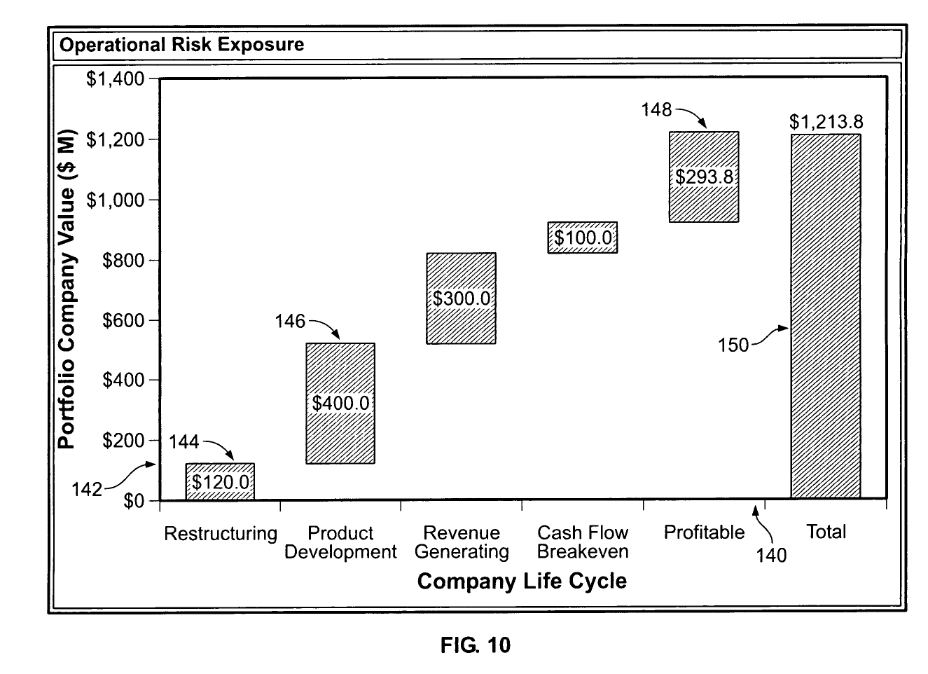

FIG. 10 exemplifies yet another embodiment of an aspect of the present invention. It is entitled “Operational Risk Exposure” and provides a visual representation of the total fund operating risk by company holding value and current position in the business development cycle. By “company holding value” is meant the fair market value that the fund manager places on its current investment in a portfolio company. FIG. 10 includes an X-axis 140 labeled Company Life Cycle and showing values or areas of “Restructuring”, “Product Development”, “Revenue Generating”, “Cash Flow Breakeven”, “Profitable” and “Total” (except for the Total) representing stages in the life cycles of the companies in which the fund is invested. The Y-axis 142 shows the portfolio company value (in $M). Also shown in FIG. 10 are geometric shapes, such as at 144, 146 and 148, corresponding to that portion of the fund's portfolio value that corresponds to the identified periods in the company life cycle. The size of geometric shapes 144, 146 and 148 are in proportion to the value of the assets corresponding to the respective period of the company life cycle represented by the geometric shapes. Additionally, it can be seen that each of the shapes for sequential stages in the company life cycle are positioned in the two dimensional area defined by axes 140 and 142 in alignment with their respective stages on the X-axis 140 and in stepped accumulation position with the geometric shape immediately adjoining the particular geometric shape. The geometric shape corresponding to the Total 150 extends upwardly from X-axis 140 to the the full value of the fund. In alternate embodiments of the present invention, the Y-axis 142 could alternatively indicate the cost basis or invested capital of the investments.

In alternate embodiments of the display method of FIG. 10 the Y-axis may indicate any selected monetary or value criteria and the X-axis may represent any selected time or maturity metric.

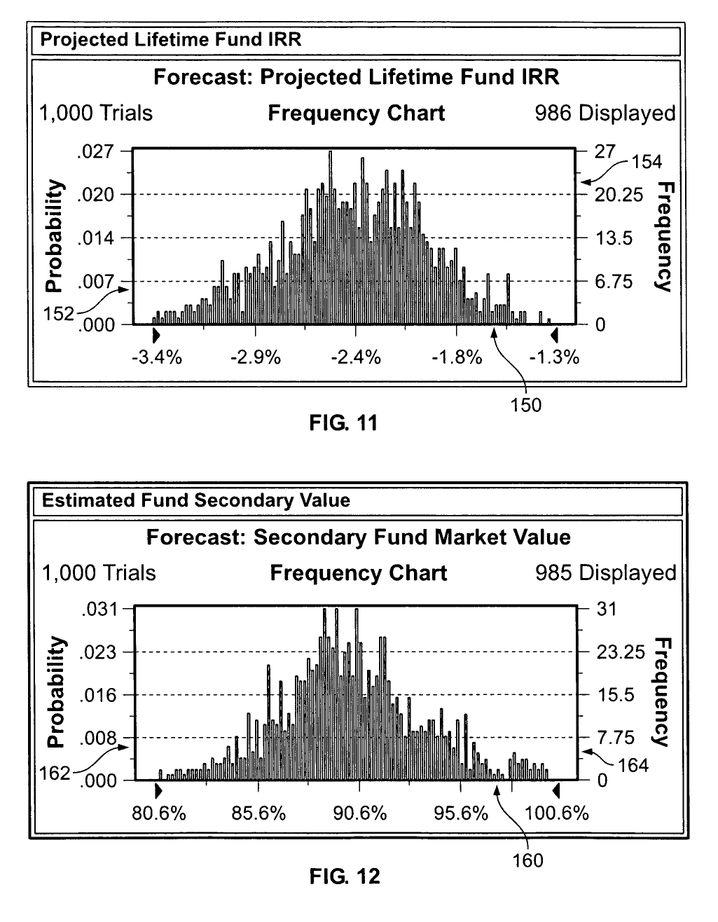

FIG. 11 represents yet another aspect of the present invention and illustrates, in the form of a histogram, the results of a Monte Carlo analysis conducted on data and input to forecast probabilities for the projected lifetime fund IRR for a particular fund. On the X-axis 150 are shown possible values for the projected lifetime fund IRR. On the left vertical axis 152 is shown probability. On the right vertical axis 154 is shown frequency. FIG. 11 indicates that for the 1000 trials run in the Monte Carlo analysis, the results of 986 trials are displayed.

FIG. 12 represents an aspect of the present invention and illustrates, in the form of a histogram, the results of a Monte Carlo analysis conducted on data and input to provide a visual representation of probabilities as to the secondary fund market value for the particular fund. On the X-axis 160 are shown possible values for the secondary fund market value. On the left vertical axis 162 is shown probability. On the right vertical axis 164 is shown frequency. FIG. 12 indicates that for the 1000 trials run in the Monte Carlo analysis, the results of 985 trials are displayed.

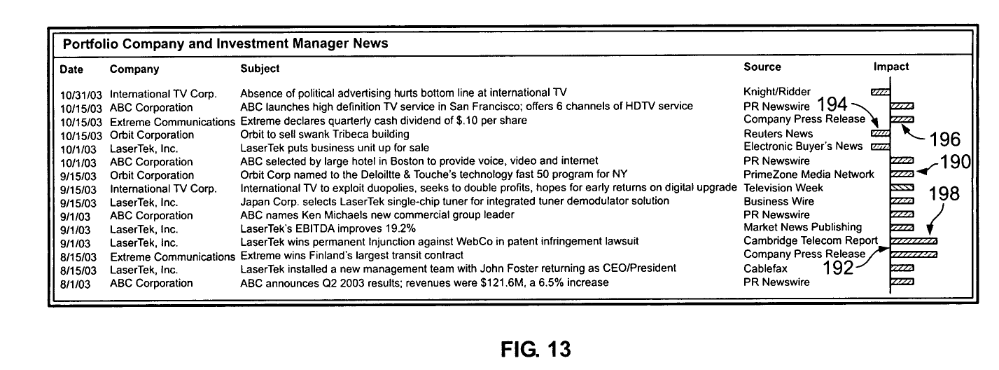

FIG. 13 illustrates and embodies another aspect of the present invention. In FIG. 13 is provided a sample update on news relating to a particular fund and in specific showing news relating to portfolio companies held by the fund and news relating to the investment managers responsible for the particular fund. The news items are provided in chronological order, recited the particular portfolio company to which the news item(s) relate, provide a description of the subject and/or substance of the news event and the source of the information of the news item. Additionally, and importantly, the display means of FIG. 13 also includes an “Impact” key or legend 190 that provides an immediate indication of the impact or effect of each particular news item. Impact key 190 includes a vertical reference baseline 192 from which indicator bars, such as illustrated at 194, 196 and 198 extend. The impact bars can be color coded to indicate whether the particular news item is deemed negative or positive by the author of the update. For, example news items deemed negative can be color coded red, while news items deemed positive can be color coded blue. Alternatively, positive and negative indicators can be provided by differentiating black and white markings such as cross-hatching or grey scale indicators. Additionally, as Shown in FIG. 13, the impact bars for news items deemed negative extend in a direction to the left of the vertical reference baseline 192, such as shown by impact bar 194. Impact bars for news items deemed positive extend in a direction to the right of the vertical reference baseline 192, such as shown by impact bar 196. Additionally, the degree of importance or impact of the particular news item is indicated by the relative size of the individual impact bars. For example, impact bar 198 indicates positive news of an importance or impact greater than the positive news item associated with impact bar 196. It will be understood that the shape of the impact bars may be arbitrarily changed as desired or replaced with other symbols or numbers of symbols to indicate whether the news item is positively or negatively viewed and the degree of impact of the news item.

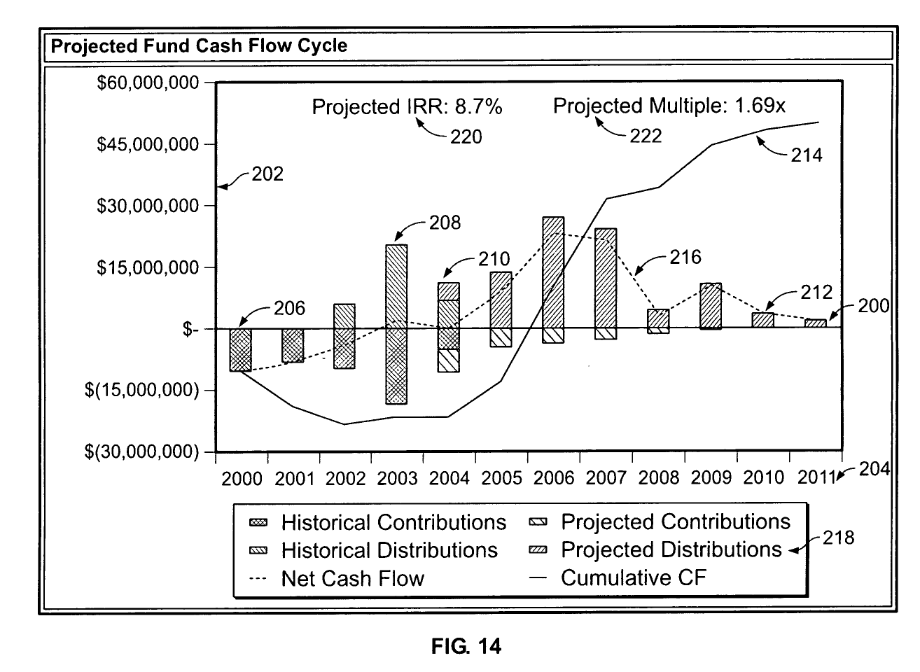

FIG. 14 illustrates additional aspects of the present invention and displays data representing a projected fund cash flow cycle for a particular fund. Shown in FIG. 14 is X-axis 200 that intersects perpendicularly with Y-axis 202. X-axis 200 represents a time line and is labeled with relevant year or time index 204. Y-axis 202 represents amounts of capital, in this instance dollars, both contributed into and distributed out of the particular fund for which the display is presented. Corresponding to respective years on X-axis 200 are superimposed graphical shapes, such as at 206, 208, 210, 212 and 214, representing the historical contributions, historical distributions, projected contributions and projected distributions as identified in legend 218. The sizes of the graphical shapes corresponds to the dollars represented. For example shape 206 represents a historical contribution to the fund in year 2000 of approximately $10,000,000. Shape 208 represents and identifies a historical contribution of approximately $17,000,000 in year 2003 and also a historical distribution of approximately $18,000,000 in the same year. Shape 210 shows amounts for the year 2004 of all of the contribution and distribution categories. FIG. 14 shows only a projected distribution in year 2010. Also shown in FIG. 14 are two lines 214 and 216, each identified in legend 218. Line 216 represents the net cash flow, on a per year basis, for the fund. Line 214 represents the cumulative cash flow for the fund. Also shown in FIG. 14 is the projected IRR 220 calculated for the fund as well as the projected multiple 222 calculated for the fund. Alternate embodiments of the aspects of the present invention exemplified in FIG. 14 may comprise different shapes or lines for representations of the data described in legend 218.

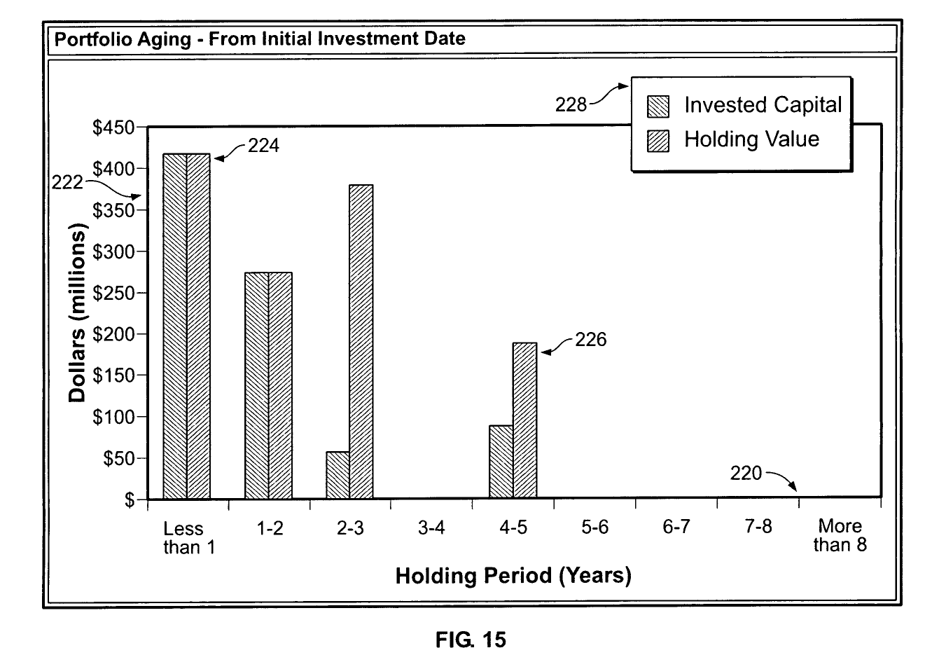

FIG. 15 illustrates an embodiment of additional aspects of the present invention and displays information relating to the portfolio aging, from the initial investment date of the fund. FIG. 15 comprises two perpendicular axis; with X-axis 220 represents the holding period, shown here in years, and Y-axis 222 representing dollars (in millions). Also shown in bar chart format are shapes such as 224 and 226 representing separately cumulative invested capital and holding value of the investment in the particular fund being represented. Legend 228 identifies the data represented by the particular shapes or bars in the chart.

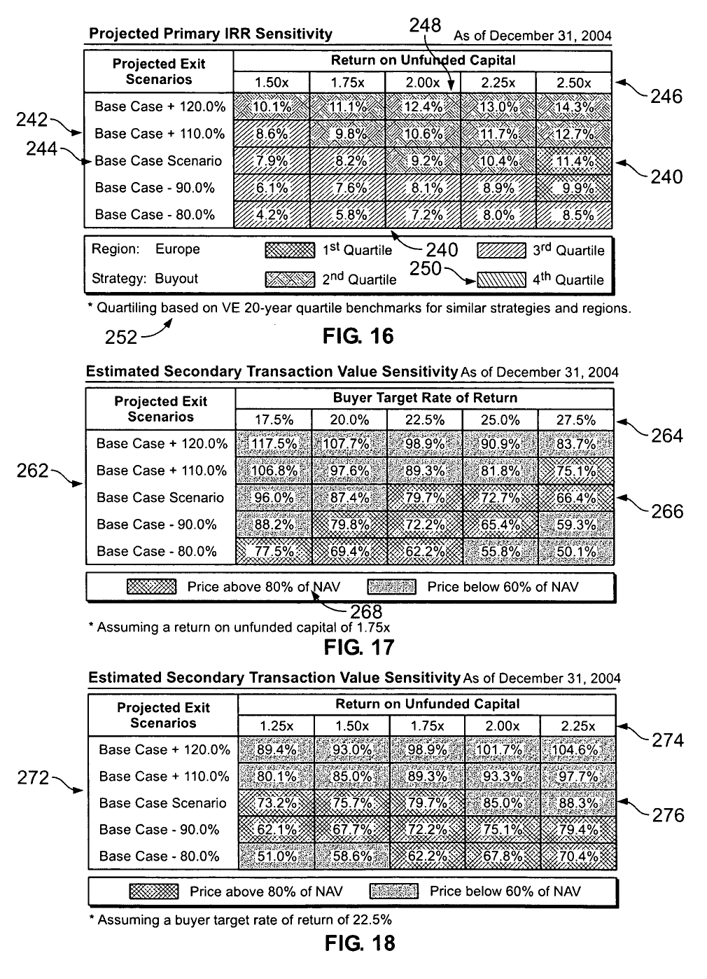

FIGS. 16-18 illustrate additional aspects of the present invention. FIG. 16 provides a visual representation of data regarding projected primary IRR sensitivity for a particular fund. Shown in the shaded boxes 240 are projected IRRs for the projected life of the fund juxtaposed in a matrix or grid. The matrix includes two indices which indicate variations in assumptions regarding performance of the fund. The vertical index 242 indicates degrees of variation from a base case scenario or projection 244 as to the IRR expected for exit scenarios for existing investments within the particular fund. As shown at 242, the variations in this index are, in addition to the base case, the base case times 80, 90, 110 and 120 percent. The horizontal index 246 indicates degrees of variation in projected return on unfunded capital indicated as projected multiples of capital. In the embodiment of FIG. 16, the projected most likely multiple is 2.00×, indicated at the middle column 248. Variations in the multiples on index 246 in the depicted embodiment are 1.50×, 1.75×, 2.00×, 2.25× and 2.50×. In the example of the base case scenario indicated at 244, it can be seen that the projected IRR increases from 7.9% to 11.4% as the multiples assumption (indicated at 246) increases from 1.50× to 2.50×.

In FIG. 16 the boxes 240 are shaded to reflect information relating to legend 250. As shown in the legend, four varieties of shading are provided, in this instance indicating whether the projected IRR of a particular box corresponds to a value in the first, second, third or fourth quartile of IRRs for similar investment type funds as of the then present time. As indicated at 252, the data for determining the quartiling breakdown was obtained from the published twenty year Venture Economics data for similar investment type funds.

FIG. 17 has a similar presentation structure as does FIG. 16 and presents a visual representation of estimated secondary transaction value sensitivity. The vertical index 262 indicates a base case scenario and variations about that scenario. The horizontal index 264 indicates variations in assumption of buyer target rate of return for a proposed secondary transaction relating to the fund. In the shaded boxes 266 are shown projected pricing of the secondary as a percentage of the present NAV of the fund for the scenarios indicated by the intersection of the respective index values. As can be seen in the base case scenario the secondary transaction value decreases from 96.0% to 66.4% as the assumption of the potential buyer's target rate of return increases from 17.5% to 27.5%. Legend 268 indicates by shading of boxes 266 the relation of the price in each box to threshold percentages defined in the legend. In the embodiment of FIG. 17, the variations in shading reflected in the legend indicate whether the projected value is above 80% of present NAV or less than 60% of present NAV.

FIG. 18 is a display of proposals of estimated secondary transaction value sensitivity in relation to a particular fund. FIG. 18 has a similar presentation structure as does FIG. 17 and varies primarily from FIG. 17 in the identity of characteristic tracked on the horizontal index 274. The vertical index 272 indicates a base case scenario and variations in the positive and negative direction from that base case. The horizontal index 274 indicates variations in assumption of return on unfunded capital. The shaded boxes 276 show the projected secondary value as a percentage of present NAV for the scenarios indicated by the intersection of the respective index values.

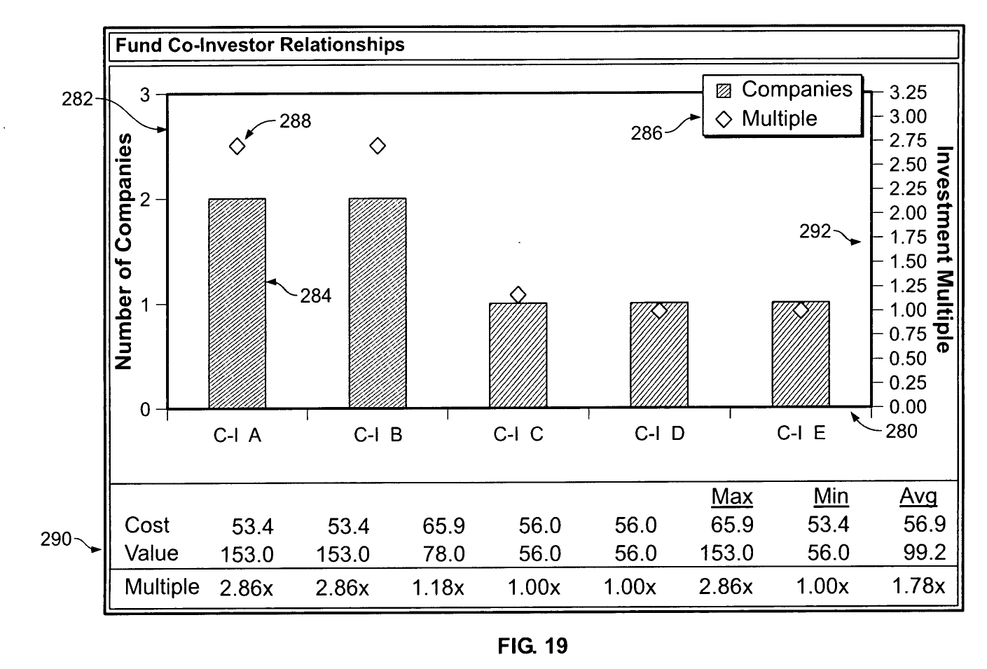

FIG. 19 illustrates additional aspects of the present invention. It provides a visual representation of important relationships and data regarding co-investors in a particular fund. Shown are X-axis 280 and Y-axis 282. X-axis 280 identifies various co-investors in the portfolio companies of the fund. The y-axis 282 indicates the number of portfolio companies in which the particular investor is a co-investor with the fund. For example, at 284 is indicated that co-investor A (another fund) is co-invested with the particular fund represented by the presentation of FIG. 19 in two of the portfolio companies of the fund. Legend 286 indicates an additional figure (in this embodiment, a diamond shape) for the “multiple”. This represents the multiple currently realized by the investment in the particular portfolio company or companies with which the figure is associated in FIG. 19. For example, the diamond at 288 indicates that the current unrealized investment multiple with regard to the two companies in which co-investor A is invested is approximately 2.9. The value of the multiple can be ascertained by reference to index 292 that shows investment multiples. The approximate number of 2.9, above, is confirmed by relation to index 290 that shows the cost, value (present value) and multiple (based on present value) for the totality of the companies recited in the respective colums of X-axis 280 that correlate to the appropriately positioned values in index 290. For example, in relation to co-investor A, the corresponding multiple figure in index 290 is 2.86×. Index 290 also shows the maximum, minimum and average cost, value and multiple for the companies represented in FIG. 19.

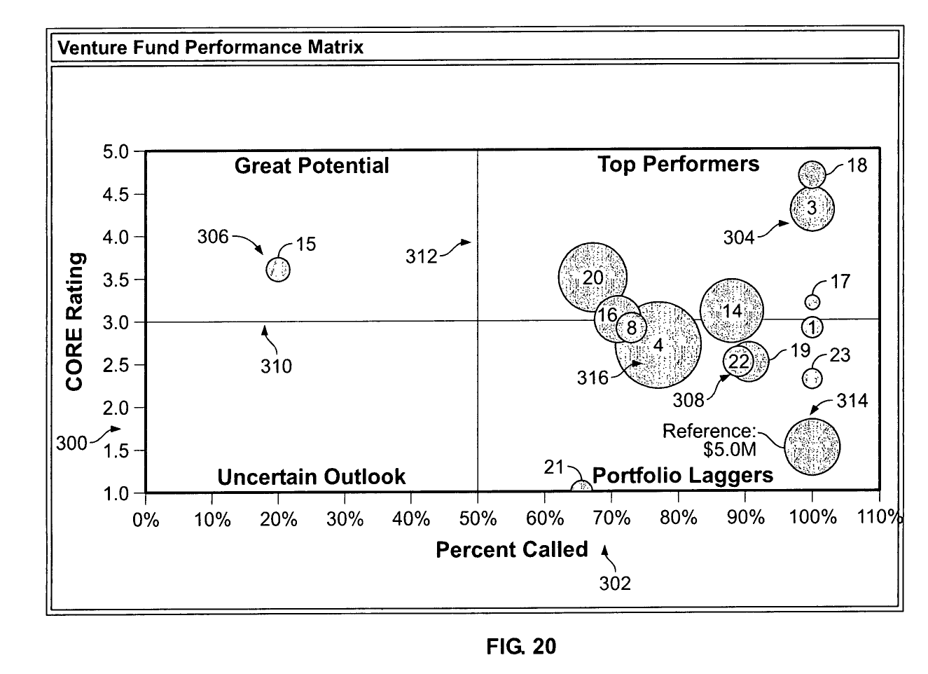

FIG. 20 illustrates an embodiment of display of venture fund performance in a matrix according to aspects of the present invention. The display of FIG. 20 is utilized in providing data relating to a portfolio of fund investments and may represent all funds of the portfolio or may, alternatively, represent only one or more subcategories of the funds of the portfolio. FIG. 20 comprises two indices, a vertical index 300 and a horizontal index 302. The vertical index 300 represents the “CORE”™ rating which is a quantitative discretionary rating of the quality of the fund. In this instance it reflects a combination of historical and projected performance of a particular fund. The horizontal index 302 represents the percent called which is how much of the fund committed capital has been contributed to date. Also included are Y-reference axis 312 and X-reference axis 310 the intersection of which is approximately centered in the area bounded by indices 300 and 302.

In FIG. 20, individual shapes, indicated by example at 304, 306 and 308 represent funds in which the portfolio is invested. In FIG. 20 the shapes are circles or bubbles, however in alternate embodiments other shapes may be used. The sizes of the bubbles are based on total exposure (NAV plus unfunded commitment) in the fund of each particular bubble. Additionally provided is a reference shape 314 which provides a visual reference for the value of the total exposures of the individual bubbles. In the embodiment of FIG. 20 the size of reference shape 314 represents five million dollars. The sizes of the individual bubbles are appropriately proportional, based on each's value, to the size of the reference shape 314. The individual shapes also include reference numbers, such as at 316. These numbers identify the particular fund represented by the shape and relate it to additional information in the overall report on the portfolio. For example, the reference number can identify the fund by relation to the identifier number 85 in a display such as exemplified in FIG. 5. (It should be noted though that the data of exemplary FIG. 20 herein is merely illustrative and does not in fact relate to the exemplary data of FIG. 5 herein and so a cross referencing between the precise data of FIG. 20 and FIG. 5 is not appropriate. In some embodiments of the present invention, it is entirely appropriate as the respective displays are designed to be mutually complimentary.)

It should be noted also that in alternate embodiments, the amounts represented by geometric shapes such as 304, 306 and 308 could alternatively represent just NAV of a fund, or just unfunded commitment relative to a fund, or total commitment size, or just contributed capital size.

In FIG. 20, four quadrants are created by axis 310 and 312, they are labelled respectively “Uncertain Outlook”, “Portfolio Laggers”, “Top Performers” and “Great Potential”. They can alternatively be labelled with other general descriptors of fund classifications. As is evident the quadrant labelled “Top Performers” is comprised of those funds having both a high CORE™ rating and that are greater than fifty percent called. They represent relatively more mature funds and so are more secure in staying in that quadrant, since by virtue of their maturity are not so likely to drop in performance. Accordingly, they are identified as “Top Performers”. In contrast the funds in the “High Potential” quadrant have a high CORE™ rating but are still immature and so have less certainty about their ultimate performance. Funds in the “Porfolio Laggers” quadrant have a low CORE™ rating and are greater than fifty percent called. These are funds that have been performing poorly and are mature and are less likely to significantly improve their performance because of the lack of a large amount of time for performance improvement.

It will be evident that the display of FIG. 20 quickly communicates a large amount of information relative to funds in a portfolio. Such information can include, the general classification (quadrant) of fund performance, the value of the fund, the relative value of the respective funds, the relative CORE™ ratings of the respective funds, the relative percent called of the funds, the relative historical performance and expected performance of the respective funds. In alternate embodiments funds of various fund types can be included in one display and so all the information above can be communicated as well as the fund type as well of each represented fund. In alternate embodiments, the label of the two indices can be interchanged with consequent repositioning of fund locations. Additionally substitute data for the respective indices can be used so long as one indicates in some way the age criteria of the funds or percent called criteria and the other indicates performance criteria of the funds.

It will be understood that the various embodiments of aspects of the present invention shown above can be adapted to display variations by changing the shape of figures or characters, converting bar charts to line charts or data point charts or similar substitutions. Additionally, color coding can be replaced by cross-hatching or other line oriented schemes to convey information indicated by appropriate legends. Also, various axis and indices can be inverted or swapped, all within the spirit of the present invention.

Aspects of the present invention also include embodiments wherein software instructions are provided to be carried out on computer systems such that computational steps are taken on data relating to target funds and portfolios and analytical results appropriate for inclusion in display forms as shown in this description are generated. Further, computer software instructions can generate, including by utilization of the generated analytical results of the computational steps, displays according to embodiments of the present invention, such, for example, as shown in the figures of this detailed description, and such displays can be printed, displayed on computer monitors or other display devices or otherwise fixed or prepared for use, study or analysis.

Additionally, other aspects of the present invention include embodiments wherein electronic data representing images according to the invention are recorded and transmitted to users that can view the images on equipment that prepares and presents visual representations of the data to a user consistent with aspects of the present invention. Alternatively printed media can be used to present embodiments of the present invention. Additionally, electronic information can be communicated over the internet or other communications routes to provide one or more users with the highly communicative data representations of the present invention.

It is also in keeping with the present invention to combine individual displays, charts, figures or reports as described herein into broader reports or presentations so that the user can easily cross-reference or assimilate information from one portion of the report to another.

An additional aspect of the present invention is to electronically link aspects of a portfolio report, which may typically include at least portions of aspects shown in FIGS. 2-6 and 20, with aspects of a fund report, which may typically include at least portions of aspects shown in FIGS. 7-19. Such linking can be effectively carried out by providing displays according to the present invention by use of equipment, such as a computer or disc player or other data handling equipment, in combination with a display so that reports can be generated by accessing data and “building” reports or displays or by accessing electronic copies of reports or displays from local memory devices or via internet or other communication channels. The user when viewing such reports or displays may select certain portions of such reports or displays and then have the system link to or call up other aspects of the present invention that relate to the particular portion selected.

For example, a report user could view a figure such as is depicted in FIG. 2 and by use of a mouse or other device select a particular fund shown in FIG. 2. The system could then call up and display various aspects of the present invention relating to the particular selected fund such as is illustrated in FIGS. 7-19 herein. Additionally, as a report user “scrolls over” particular figures, data or shapes in the reports, underlying data can be displayed in mini-displays on the display. Additionally smaller versions of full charts or figures of the present invention can be shown on the periphery of the display when the report user “scrolls over” particular figures, shapes or data in the reports. The report user may preselect preferences of what additional data, charts or representations are called up and displayed by various selection events or scrolling actions.

While features and advantages of the invention have been described and pointed out as applied to the present embodiments, those skilled in the art will appreciate that various modifications, changes, additions and omissions in the devices, methods and system illustrated and described herein can be made without departing form the spirit of the invention.

What is claimed is:

1. A method of presenting analytics relating to fund investment return expectations for a plurality of funds held, comprising:
a. Presenting a first axis representing expected fund performance
b. Presenting a second axis representing historical fund performance
c. Positioning in relation to the first and second axis a first geometric shape representing a first fund, the positioning of the first geometric shape being at the intersection of the funds' historical and expected performance relative to the first and second axes,
d. Positioning in relation to the first and second axis a second geometric shape representing a second fund, the positioning of the second geometric shape being at the intersection of the funds' historical and expected performance relative to the first and second axes,
e. The sizes of the first and second geometric shapes being respectively proportional to the amount of investment held in the first and second funds, respectively.

2. A method of presenting analytics relating to the bandwidth of general partners managing a fund, comprising:
a. Providing an at least two dimensional area
b. Providing in such at least two dimensional area a first axis representing holding value under management by a particular general manager,
c. Providing in such at least two dimensional area and approximately perpindicular to said first axis, a second axis representing an identifier for individual general partners involved in the management of the fund,
d. Providing in the two dimensional area at least one geometric shape corresponding to each of a plurality of said general partners,
e. Positioning each said geometric shape at the appropriate intersection of general manager identifier of said second axis and holding value position on said first axis.
